(19) United States
(12) Patent Application Publication
(10) Pub. No.: US 2004/0267715 A1
(43) Pub. Date: Dec. 30, 2004

(54) Processing TOC-less media content

(75) Inventors: Michael J. Polson, North Bend, WA (US); David W. Hostetter, Redmond, WA (US); Thomas B. Springer, Redmond, WA (US)

Correspondence Address: LEE & HAYES PLLC, 421 W RIVERSIDE AVENUE SUITE 500, SPOKANE, WA, 99201

(73) Assignee: MICROSOFT CORPORATION, REDMOND, WA (US)

(21) Appl. No.: 10/606,590

(22) Filed: Jun. 26, 2003

(51) Int. Cl. G06F 17/30

(52) U.S. Cl. 707/3

(57) ABSTRACT

Methods and systems are described that greatly enhance a user's experience when playing media content that does not include a table of contents (e.g. MP3 and WMA files), herein referred to as TOC-less media content. One or more databases, managed by a server, maintain metadata associated with various media. When a user requests metadata associated with TOC-less media content, search criteria is extracted from the file containing the TOC-less media content, and a metadata search is performed. Sets of metadata that may be associated with the metadata are then returned for display to the user. A user may select one of the returned results to be associated with the TOC-less media content, revise the search criteria and execute another search, or manually enter metadata that is to be associated with the TOC-less media content.

### TECHNICAL FIELD

This invention relates to processing media content that lacks a table-of-contents.

### BACKGROUND

With the technological advance of computers and the software that runs on computers, users are now able to enjoy many features, which just a few years ago, did not exist. For example, users can now play various media and multimedia content on their personal or laptop computers, thus providing an improved user experience. For example, most computers today are able to play compact discs (CDs) so that a user can listen to a favorite artist or artists while working on their computer. Additionally, users are now able to “rip” music from a CD to be stored on a computer system in file formats such as .MP3 or .WMA (Windows Media Audio).

As users become more used to advanced features on their computers, such as those mentioned above, their expectations of the various additional innovative features will undoubtedly continue to grow. For example, consider a media player software application that enables a user to play a CD or .MP3 file on their computer. Typical applications allow a user to display, via the use of a mouse, metadata that is associated with the CD by clicking on an appropriate user interface (UI). Such CD metadata typically includes album name, artist name, and song titles. The metadata is not stored on the CD, but is stored in a data repository that can be accessed, for example, over the Internet. The CD includes a structure referred to herein as a table of contents (TOC) that is used to identify the CD. The TOC format, which is defined by the well-known Red Book Audio Standard, specifies the number of tracks, offset of each track on the CD, and the lead out value. The TOC is used as a key to access the data repository that contains CD metadata. To further enhance a user's experience, systems have been developed that allow a user to access additional metadata associated with a particular CD, including, for example, album art, lists of similar artists, links to websites where similar music can be purchased, and so on. The additional metadata may also be accessed based on the Table of Contents.

In contrast to a CD, .MP3 files (and other audio files ripped from a CD) typically do not include a TOC or other unique identifier, but instead include a defined structure (known as ID3 tags or “attribute tags”) for storing textual metadata associated with the media contained in the file. (Audio files ripped using Windows Media Player are an exception in that the TOC of the CD is added to the WMA file when the file is ripped.) The textual metadata stored in the ID3 or attribute tags typically includes an artist name, a track name, and an album name. Unfortunately, however, in many instances, the attribute tags are either not included, or are manually entered by a user, often resulting in missing or erroneous metadata. Such media files that do not include a TOC are generally referred to herein as “TOC-less media”.

Accordingly, this invention arose out of concerns associated with providing improved systems and methods for processing TOC-less media content to provide an improved, rich, and robust user experience.

### SUMMARY

Methods and systems are described that greatly enhance a user's experience when playing media content that does not include a table of contents (e.g. MP3 and WMA files), herein referred to as “TOC-less media content”. One or more databases, managed by a server, maintain metadata associated with various media. The metadata can include any type of additional information that can be of interest to a user or consumer of the media. However, because the media content does not include a table of contents, identifying associated metadata is not straightforward. In a described implementation, search criteria may be extracted from attribute tags that are associated with the media content. In an event that the attribute tags are blank, search criteria may be extracted by parsing a filename associated with the TOC-less media content.

Because the search criteria is likely to not be complete, several potentially related sets of metadata may be returned as search results. In an exemplary implementation, a user can select one of the returned sets of metadata, causing the metadata to be associated with the TOC-less media in a local media library. Alternatively, a user can modify the search criteria and perform another search, in an attempt to identify metadata that should be associated with the TOC-less media. Another alternative enables a user to manually enter metadata to be associated with the TOC-less media.

### BRIEF DESCRIPTION OF THE DRAWINGS

FIG. 1 is a diagram that illustrates an exemplary environment in which TOC-less media content can be processed.

FIG. 2 illustrates an exemplary screen display of track details associated with TOC-less media content.

FIG. 3 illustrates the top portion of an exemplary search results screen display.

FIG. 4 illustrates the bottom portion of an exemplary search results screen display.

FIG. 5 illustrates an exemplary album details screen display.

FIG. 6 illustrates an exemplary updated track details screen display.

FIG. 7 illustrates an exemplary refine search screen display.

FIG. 8 illustrates an exemplary edit track information screen display.

FIG. 9 is a flow diagram that illustrates exemplary processing of TOC-less media content.

FIG. 10 is a flow diagram that illustrates a method for identifying metadata that may be associated with TOC-less media content.

FIG. 11 is a flow diagram that illustrates a method for associating identified metadata with TOC-less media content.

FIG. 12 is a flow diagram that illustrates a method for enabling a user to modify search criteria used to identify metadata that may be associated with TOC-less media content.

FIG. 13 is a flow diagram that illustrates a method for associating user-supplied metadata with TOC-less media content.

FIG. 14 is a block diagram that illustrates selected components of a computing environment in which TOC-less media content processing can be implemented.

### DETAILED DESCRIPTION

Overview

Compact discs (CDs) that are formatted according to the industry standard Red Book Audio Standard include a table of contents (TOC). The TOC can be used as a key to a database to lookup metadata associated with the media content stored on the CD. The embodiments described below provide methods and systems that enable a user or, more accurately, an enabled media player that is executing on a computing device or client, to access, retrieve, and display for a user, metadata that is associated with TOC-less media content that is being played using the media player. A search against a server-based metadata database is performed, and metadata is returned to the user's computing device, for example to be stored in a local media library. Furthermore, the enabled media player uses the retrieved metadata to update attribute tags that are associated with the media content. In the examples that are given below, the TOC-less media content is described in the context of content that is embodied in an .MP3 file. It is to be appreciated and understood that the TOC-less media content can be embodied on any suitable media, such as in a .WMA file, and that the specific examples described herein are given for illustrative purposes to assist the reader in understanding the inventive principles.

Various features of the described systems and methods include one or more databases, client side executable code, and a series of server side processes that provide for querying and maintaining the databases. One logical organization of an exemplary system includes the following: (1) a process to extract search criteria from a TOC-less media file, (2) a process to allow a user to modify the extracted search criteria, (3) a query process to retrieve information from a database based on the extracted search criteria, and (4) a process to update a local media library with metadata that a user identifies as being associated with the TOC-less media content.

The resultant system provides a user with the ability to access additional metadata and context-sensitive related data (e.g. cover art, performer biographies, reviews, related performers, where to buy similar items, upcoming concerts, ticket sales, URLs to other related experiences including buying experiences, and the like) that may be associated with media content that lacks a table of contents.

Exemplary Environment

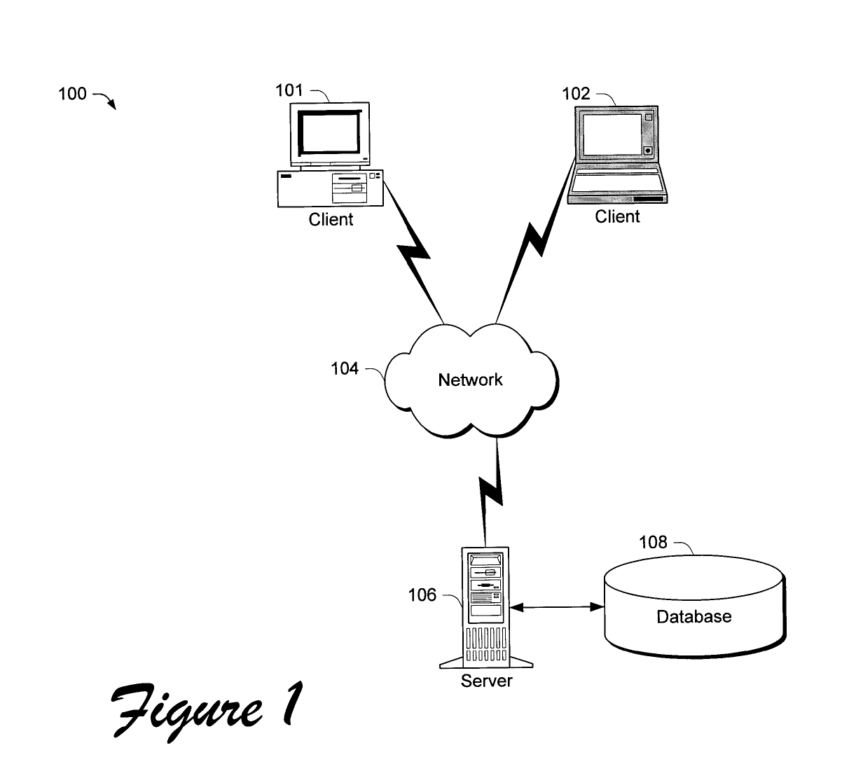

FIG. 1 shows an exemplary environment 100 in which the embodiments described below can be implemented. The environment 100 includes one or more client computers—here 101, 102, a network 104, one or more server computers 106, and one or more databases 108. An exemplary network comprises the Internet, although any suitable network can be used.

In this environment, a user on the client side opens a file containing TOC-less media content using a media player application on their computer, or otherwise causes TOC-less media content to be experienced. The media content is identified by data in embedded attribute tags (if present), the filename, and/or user-submitted data, which is then used to search a database 108 for associated metadata. The metadata is then returned to the client via network 104 and displayed for the user. When the user identifies and selects displayed metadata that should be associated with the TOC-less media content, the metadata is stored in association with the media content in a local media library. In an exemplary implementation, the file containing the media content may also be modified to include a unique identifier that is also a key in the metadata database. The unique identifier can then be used at a later time, for example, to access additional metadata associated with the media content.

The description below will provide detailed aspects of the above systems and various methods that all contribute to a much richer user experience.

Wizard

In an exemplary implementation, a series of user interface screens, referred to herein as a “Wizard”, is provided to assist a user in identifying metadata associated with media content that lacks a table of contents so that a local media library can be updated to include metadata associated with the media content. The Wizard also enables a user to enter metadata associated with the media content in the event that existing metadata associated with the media content cannot be identified. The description below presents but one implementation of a Wizard that can be used to identify, edit, and/or generate metadata associated with TOC-less media content.

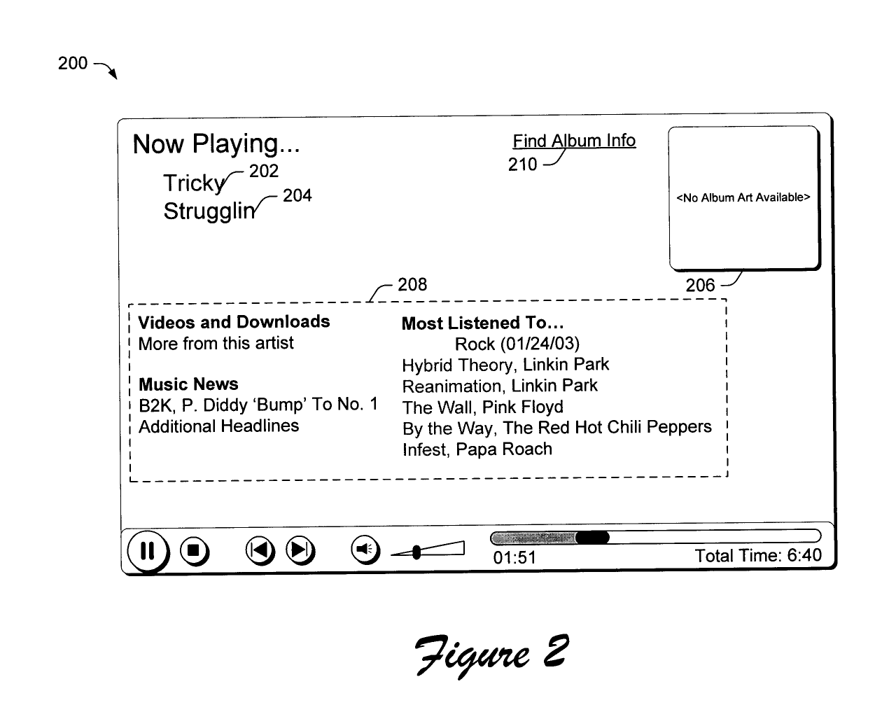

FIGS. 2-8 show select screens of an exemplary Wizard user interface that can be provided in one implementation. FIG. 2 illustrates a track details screen 200 that is displayed on a client machine when a particular file containing TOC-less media content is being played using a media player application. In the illustrated example, a file with the filename “struggling.mp3” is being played. The file includes data in the ID3 tags that identify the artist and the track name, but no data in the ID3 tag that identifies the album name. The artist is identified as “Tricky” (as indicated by the displayed artist name 202) and the track name is identified as “Strugglin” (as indicated by the displayed track name 204). Because the album name ID3 tag is blank in the .mp3 file, the media player has no way of knowing what album the song being played is associated with. Accordingly, no album art is displayed in the album art area 206. Furthermore, the related information area 208 contains data that may not be contextually relevant to the music that is currently being played. Because the media player cannot identify an album associated with the currently playing media content (due to the fact that the album name ID3 tag is blank), track details screen 200 also includes a selectable Find Album Info link 210 that enables a user to launch a media identification process.

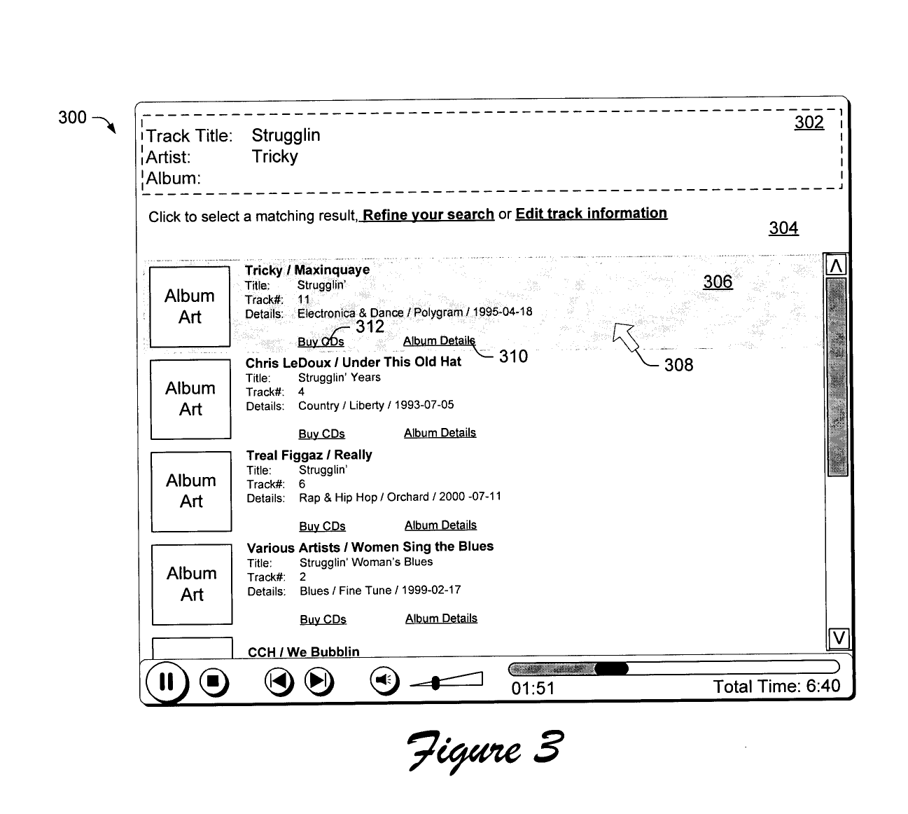

FIG. 3 illustrates the top portion of an exemplary initial results screen 300, which displays results of an initial search for album information based on the limited data that is available in the ID3 tags. In the illustrated example, the track name, “Strugglin” and the artist name “Tricky” are compared to data stored in a database. Due to the fact that the data in the ID3 tags may have been manually entered by a user, there is no guarantee that the provided data (e.g., track name and artist name) is correct or spelled correctly. Accordingly, in an exemplary implementation, an enhanced text search is performed to increase the chances of finding data associated with the correct album. Any of a number of enhanced search techniques may be implemented to reduce the possibility of the correct album not being returned due to, for example, a spelling, formatting, or punctuation difference between the data in the database and the data in the ID3 tags. It will be appreciated that such search techniques are well known to those skilled in the art.

Initial results screen 300 includes a track information area 302 in which known information associated with the current track is displayed. Search results are displayed in the lower portion of the screen 304. Data associated with each album that is identified as a potential match is displayed in an area known as a tile 306. In the illustrated example, each tile displays the album art associated with the album, the artist name/album name, the track title, the track number, a genre, record label, and release date. In the illustrated exemplary implementation, when a user moves the cursor 308 over a tile 306, the tile is highlighted, and can be selected, for example, by the user clicking the mouse.

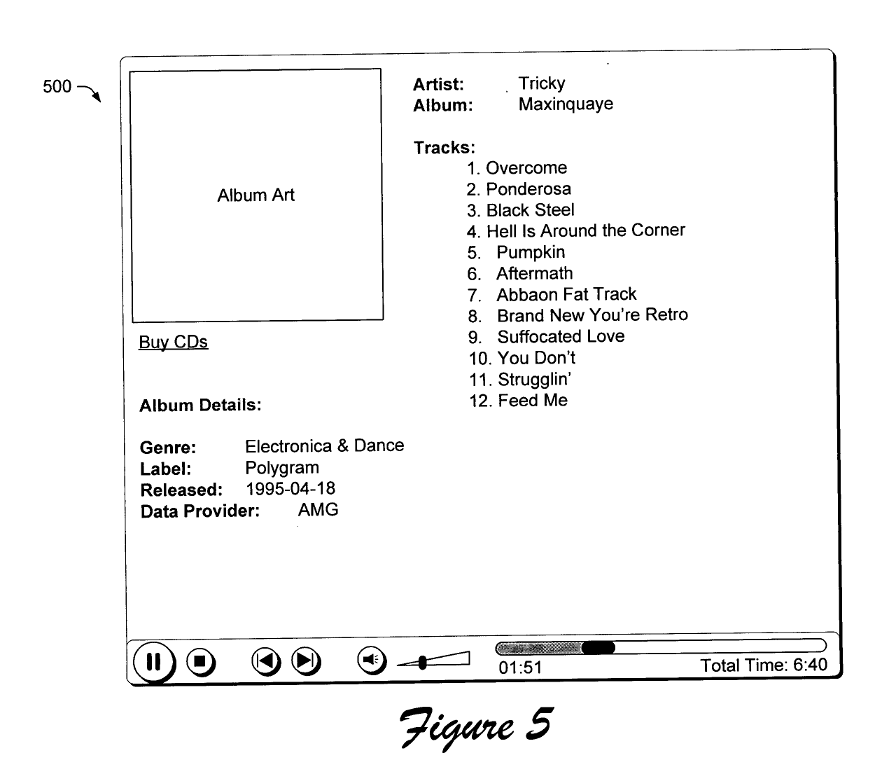

Besides being a selectable entity in and of itself, each tile also includes two selectable links; an Album Details link 310 and a Buy CDs link 312. In the illustrated example, when a user selects the Album Details link 310, an album details page is displayed, which includes a complete list of tracks on the album (an exemplary album details page is described in more detail below, with reference to FIG. 5). When a user selects the Buy CDs link 312, a music retailer website is displayed, allowing the user to purchase the identified album or other media selections.

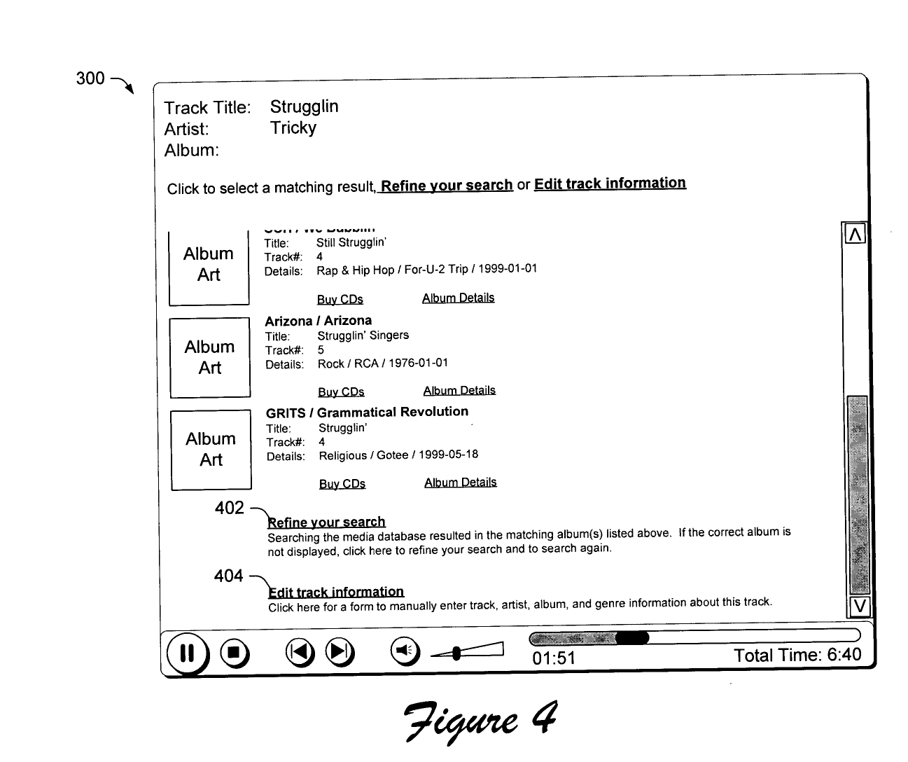

FIG. 4 illustrates the bottom portion of the exemplary initial results screen 300. In the illustrated example, two additional options are provided to the user in an event that the returned results do not include the album with which the media content should be associated. A refine search link 402 is provided that, when selected, enables a user to modify the search criteria in a continued effort to locate metadata associated with the TOC-less media content. An edit track information link 404 is provided that, when selected, enables a user to manually enter metadata to be associated with the current TOC-less media content.

FIG. 5 illustrates an exemplary album details page 500 that is displayed when the user selects an album from the results list shown in FIG. 3. Album details page 500 allows a user to view all of the available data associated with the album to help the user determine whether or not the selected album is indeed the album that should be associated with the media content currently being played.

When a user selects a particular search result tile, as illustrated in FIG. 3, the metadata associated with the selected album is associated with the currently playing media content in a local media library on the user's client computer system. After the selected album data is associated with the media content, an updated track details screen is then displayed.

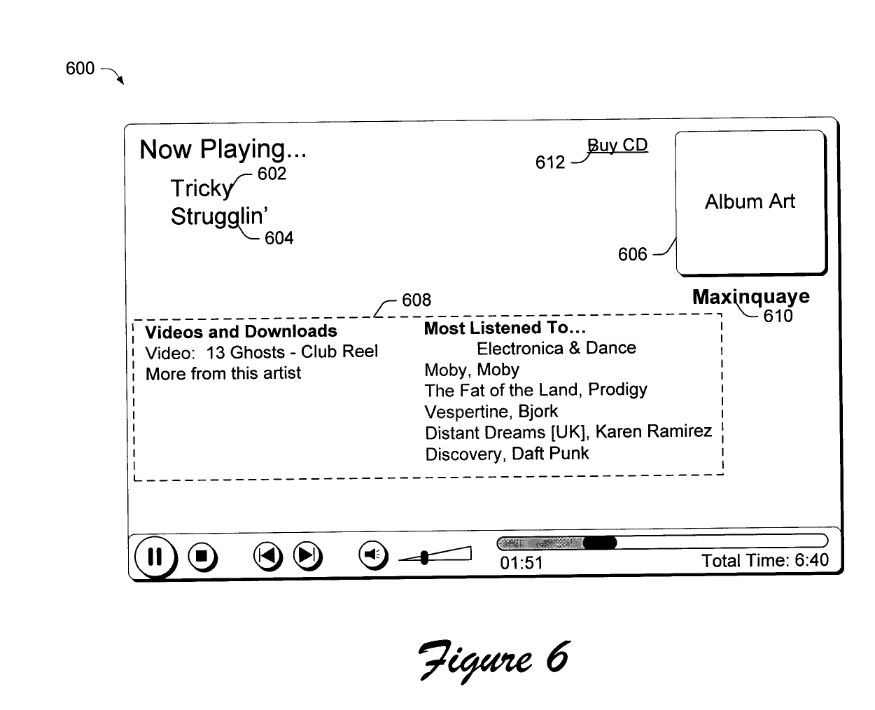

FIG. 6 illustrates an example display of an updated track details screen 600 (which is similar to the track details page 200, illustrated in FIG. 2) that is rendered after a particular album is selected as being associated with the TOC-less media content that is being played. As can be seen by comparing the data displayed in track details screen 200 in FIG. 2 and updated track details screen 600 in FIG. 6, more complete and context-sensitive metadata is displayed after the selected album metadata is associated with the media content. For example, as illustrated in FIG. 6, for the illustrated example, artist name 602 is the only data element displayed in updated track details screen 600 that is the same as the corresponding data element displayed in track details screen 200 (shown in FIG. 2). The track name 604 has been updated from “Strugglin” to “Strugglin'” to include the apostrophe at the end of the word; the actual album art is displayed in album art area 606, where in FIG. 2, there was no album art available to be displayed; and related information area 608 includes data that is more contextually relevant (e.g., based on the genre associated with the media content) than that displayed in related information area 208 illustrated in FIG. 2. Furthermore, updated track details screen 600 includes the album name 610, which was not previously available. Another difference between track details screen 200 and updated track details screen 600 is that in track detail screen 200, a find album info link 210 is displayed, allowing the user to search for metadata associated with the current media content; on the other hand, in updated track details screen 600, a buy CD link 612 is displayed allowing the user to access a retail site through which the album may be purchased. The buy CD link 612 could not be displayed on track details screen 200 because there was no information available identifying the album associated with the current media content. Similarly, the find album info link 210 does not need to be displayed in updated track details screen 600 because the appropriate album metadata has already been associated with the media content.

FIG. 7 illustrates an exemplary display of a refine search screen 700 that is displayed in response to user selection of the refine search link 402 on initial results screen 300, as illustrated in FIG. 4. Refine search screen 700 displays the media content filename 702, which is not editable; a track title field 704, which is initially populated with the value of the track title ID3 tag; an artist name field 706, which is initially populated with the value of the artist name ID3 tag; and an album name field 708, which is initially populated with the value of the album name ID3 tag. A user can correct any erroneous data that is displayed and/or add any known additional data. Selecting the search button 710 causes another search to be performed with the updated search criteria, returning another search results screen, similar to the initial search results screen 300, as illustrated in FIGS. 3 and 4.

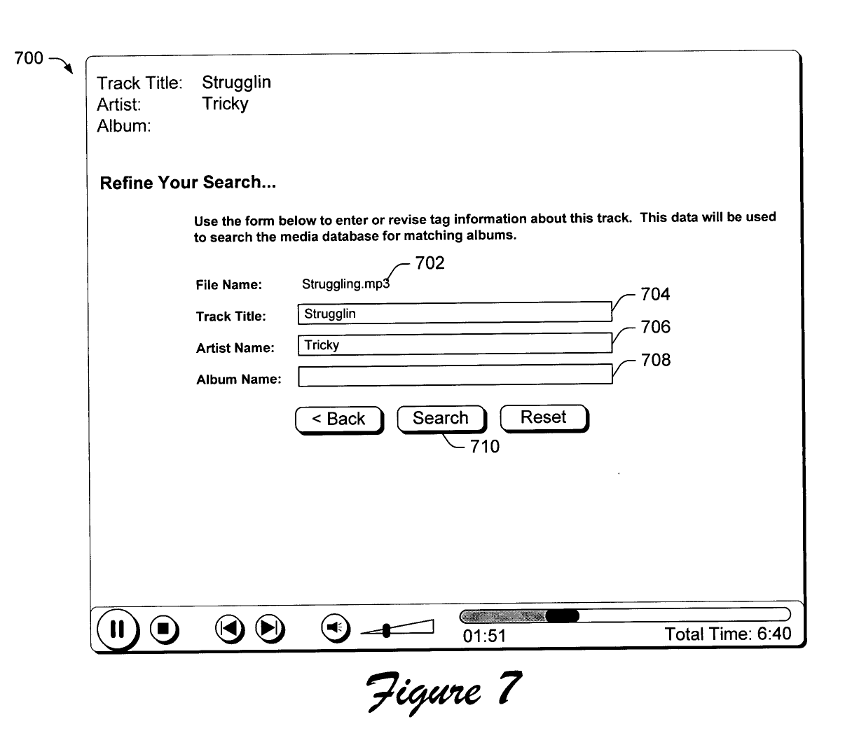

FIG. 8 illustrates an exemplary display of an edit track information screen 800 that is displayed in response to user selection of the edit track information link 604 on results screen 300, as illustrated in FIG. 4. Edit track information screen 800 displays the media content filename 802, which is not editable; a track title field 804, which is initially populated with the value of the track title ID3 tag; an artist name field 806, which is initially populated with the value of the artist name ID3 tag; an album name field 808, which is initially populated with the value of the album name ID3 tag; a genre field 810, which is initially blank; and a track number field 812, which is initially blank. A user can correct any erroneous data that is displayed and/or add any known additional data. Selecting the save and finish button 814 causes the metadata to be associated with the current media content in the user's local media library. After the data is saved, a track details screen similar to those illustrated in FIGS. 2 and 6 is displayed, such that the metadata that was entered by the user is displayed and may be used to identify context sensitive related data, based, for example, on the genre. In the 11 illustrated example, genre field 810 is implemented as a drop down list to ensure that the selected genre is recognizable by a system that may be used to identify context sensitive related data based on the genre.

TOC-Less Media Content Processing

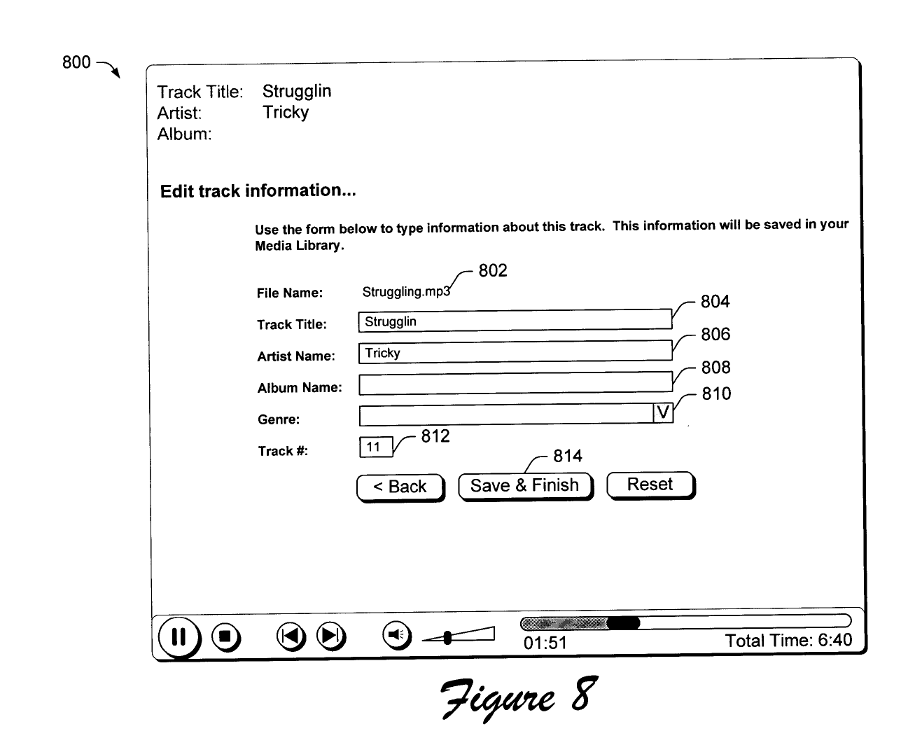

FIG. 9 is a flow diagram that describes a method 900 for processing TOC-less media content performed as a result of user interaction with a Wizard user interface. The method can be implemented in any suitable hardware, software, firmware or combination thereof. In the illustrated and described implementation, the method is implemented in software. This software can reside on the server side of the system or on the client side of the system. In this particular example, portions of the software reside on both the server and client sides of the system. To this extent, FIG. 9 is divided into two different sections-one labeled “Client side” to depict processing that occurs on the client side, and one labeled “Server side” to depict processing that occurs on the server side.

At block 902, TOC-less media content is being played using a media player on a client computer system. For example, an .MP3 file is played using a Windows Media Player application. An exemplary screen display of track details that may be displayed by such a media player is described above with reference to FIG. 2.

At block 904, a media identification process is launched. For example, as described above with reference to FIG. 2, a user selects a find album details link from a track details screen that displays metadata associated with TOC-less media content.

At block 906, any metadata that is stored in tags associated with the media content is extracted. For example, if the media content is stored as an .MP3 file, the data in the ID3 tags is extracted. In the described exemplary implementation, ID3 tags may store any combination of artist name, track name, and album name, although it is common for all three of the ID3 tags to be blank. In an exemplary implementation, in an event that all three ID3 tags are blank, the filename (not including the extension) may be presumed to be the track name. Alternatively, if the filename includes a “-”, it may be presumed that the filename is of the form “artist name”-“track name”, in which case, the filename is parsed based on the “-” and the first portion is presumed to be the artist name and the second portion is presumed to be the track name. The foregoing examples are merely a sample of possible data extraction techniques. It is contemplated that additional common file naming practices may be considered, and that additional parsing and data assignments may be implemented based thereon.

At block 908, search parameters are formatted and sent from the client to the server. In an exemplary implementation, the following data is sent as a search request:

attribute tag values (if available);

Media player version;

User Locale ID in hex (lcid);

Media ID (if available); and

Request ID.

The attribute tag values are to be used as search parameters for finding metadata associated with the current media content. The media player version is used to determine client capabilities and implement response format versioning. The lcid is passed so that data can be returned in an appropriate format. For example, in the described exemplary implementation, non-data strings are displayed by the media player in a language that is associated with the lcid of the user's browser settings. Furthermore, Unicode input is supported, allowing users to input metadata in multiple languages, not limited to those supported by ANSI or ASCII. The media ID is an identifier that is assigned to the media content, and is used as a database key when looking up metadata associated with the media content. Typically, the first time a search is performed, and until a result is selected by a user, the media ID is blank. After an associated album is identified, the media ID associated with the album may be added to the media file to facilitate subsequent searches for additional or updated metadata associated with the media content. The request ID is an identifier that is assigned by the Wizard on the client side, and is used to later match results returned from the server with the appropriate search request from which they originated.

In an exemplary implementation, search parameters are passed as a formatted XML file. Other scenarios are also contemplated in which various other techniques may be used to pass the search parameters from the client to the server.

At block 910, the server performs an enhanced text search. In an exemplary implementation, a query is performed against the enhanced text matching database 912 using the submitted search terms, resulting in a list of Media IDs for possible matches. This list of Media IDs is then submitted as a query against the music metadata database 914, which stores metadata associated with music albums. The results of the search are then returned to the client.

At block 916, the search results are displayed, for example, as illustrated in FIGS. 3 and 4.

At block 918, the client receives an indication of any one of a number of user-submitted commands. In an exemplary implementation, the possible user commands include album details, select match, refine search, manual edit, and buy CDs.

At block 920, in an event that the user submits an album details command at block 918 (e.g., by selecting the album details link 310 as illustrated in FIG. 3), a client-side display album details process is called, and a media ID associated with the album for which details were requested is sent to the server.

At block 922, a server process requests the album details from the music metadata database 914, and returns the album metadata to the client for display to the user. An exemplary display of album details is described above with reference to FIG. 5.

At block 924, in an event that the user submits a select match command at block 918 (e.g., by selecting an album that is displayed in the search results as illustrated in FIG. 3), a client side request album metadata process is called and a media ID associated with the album for which details were requested is sent to the server. The server side process described above with reference to block 922 is then performed, and the results are returned to the client.

At block 926, the client performs an update media library process to add the metadata to the user's local media library 928 such that the metadata is associated with the the TOC-less media content. In an exemplary implementation, the media ID associated with the selected album is also added, for example, as a binary GUID, to the TOC-less media content file.

At block 930, in an event that the user submits a refine search command at block 918 (e.g., by selecting the refine search link 402 as illustrated in FIG. 4), a client side refine search criteria process is called. In the described exemplary implementation, the refine search criteria process causes a screen to be displayed (e.g., as illustrated in FIG. 7) that allows a user to modify the search criteria. The modified search criteria is then formatted, sent to the server, and processed as described above with reference to blocks 908 and 910. The search results are then returned to the client and displayed as described above with reference to block 916.

At block 932, in an event that the user submits a manual edit command at block 918 (e.g., by selecting the edit track information link 404 as illustrated in FIG. 4), a client side manual edit process is called. In the described exemplary implementation, the manual edit process causes a screen to be displayed (e.g., as illustrated in FIG. 8) that allows a user to manually enter metadata to be associated with the media content. When the user submits the manually entered metadata, the client-side update media library process is called, as described above with reference to block 926 to add the submitted metadata to the user's local media library 928. In an exemplary implementation, a unique media ID is associated with the user-submitted data and with the TOC-less media content.

At block 934, in an event that the user submits a buy CDs command at block 918 (e.g., by selecting the buy CDs link 312 as illustrated in FIG. 3), a client-side buy CDs process is launched that causes a screen to be displayed that is associated with a retailer through which the user can purchase media content.

Exemplary Metadata Identification Methods

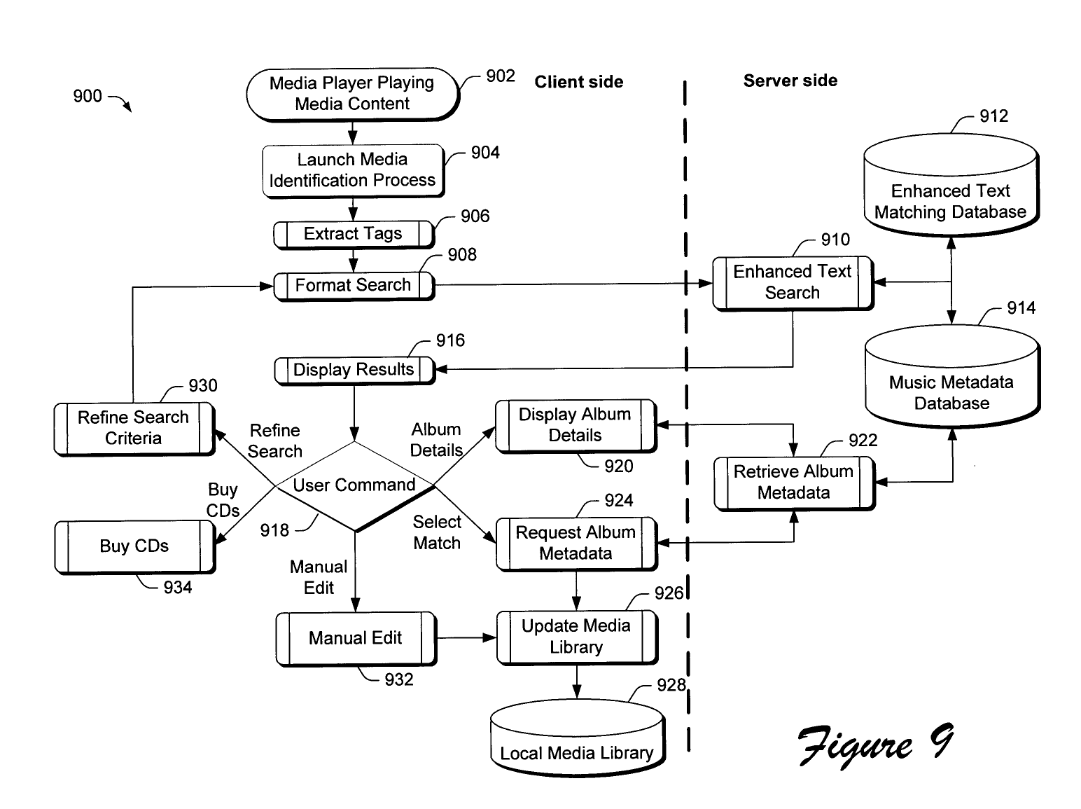

FIGS. 10-13 illustrate flow diagrams that describe methods for identifying metadata to be associated with TOC-less media content. The described methods can be implemented in any suitable hardware, software, firmware or combination thereof. In the illustrated and described implementation, the methods are implemented in software. This software can reside on the server side of the system or on the client side of the system.

FIG. 10 illustrates a method 1000 for identifying metadata that may be associated with TOC-less media content.

At block 1002, a file containing TOC-less media content is opened, for example, using a media player on a client computer system. This corresponds to block 902, as illustrated in FIG. 9.

At block 1004, the system receives a request for metadata that may be associated with the TOC-less media content. This corresponds to block 904, as illustrated in FIG. 9.

At block 1006, the system extracts search criteria from the TOC-less media content file. As described with above, with reference to block 906 of FIG. 9, data may be extracted, for example, from ID3 tags of an MP3 file, from attribute tags of a WMA file, or by parsing a filename associated with the TOC-less media content file.

At block 1008, the system submits the extracted search criteria to a metadata search system. In the described implementation, the metadata search system is executed on a server computer system.

At block 1010, the system receives search results based on the submitted search criteria. In an exemplary implementation, metadata results are returned as XML-formatted data. The received results may range from no results to many results, where each result is a set of metadata associated with a particular album on which the TOC-less media content may be a track.

At block 1012, the search results are displayed to the user. For example, a results screen similar to the one illustrated in FIGS. 3 and 4 may be rendered to display the search results.

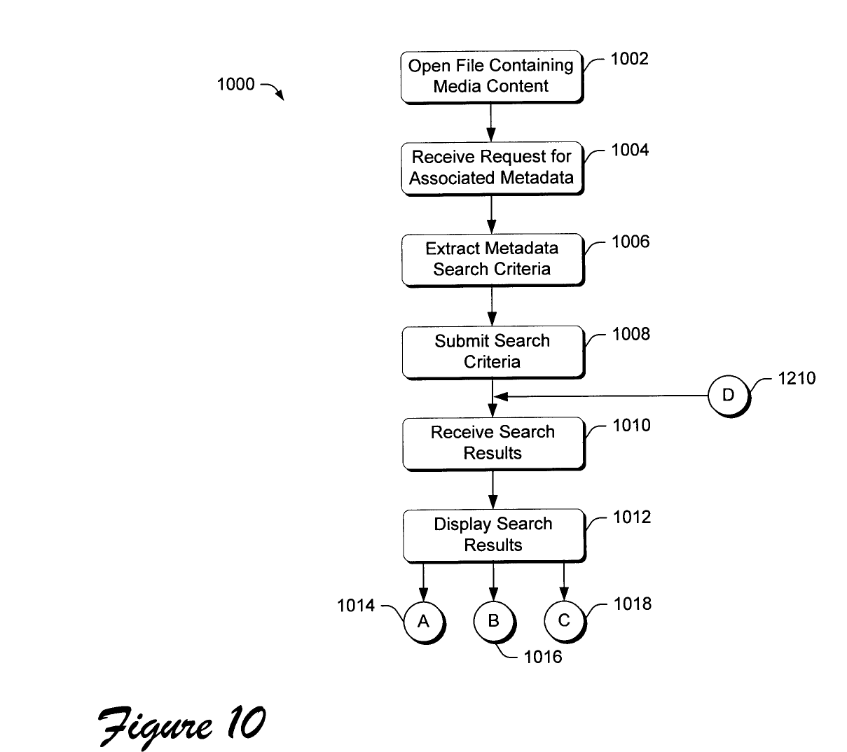

Block 1014 represents the entry point to a method 1100 (described below with reference to FIG. 11) for associating with the media content a particular one of the metadata sets that was returned as a search result.

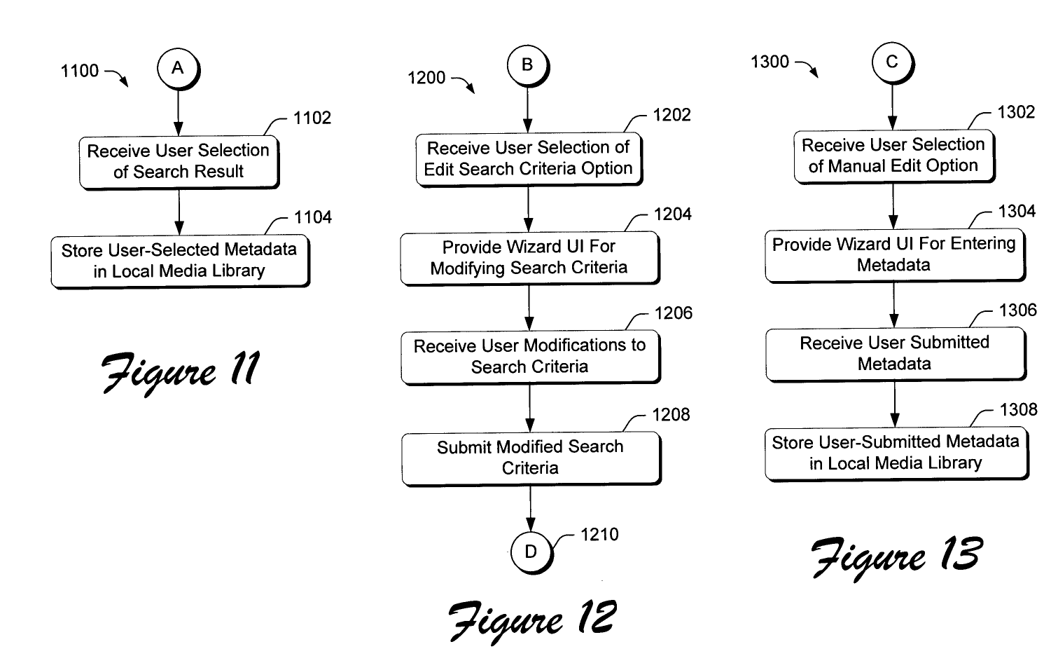

Block 1016 represents the entry point to a method 1200 (described below with reference to FIG. 12) for performing an additional metadata search with modified search criteria.

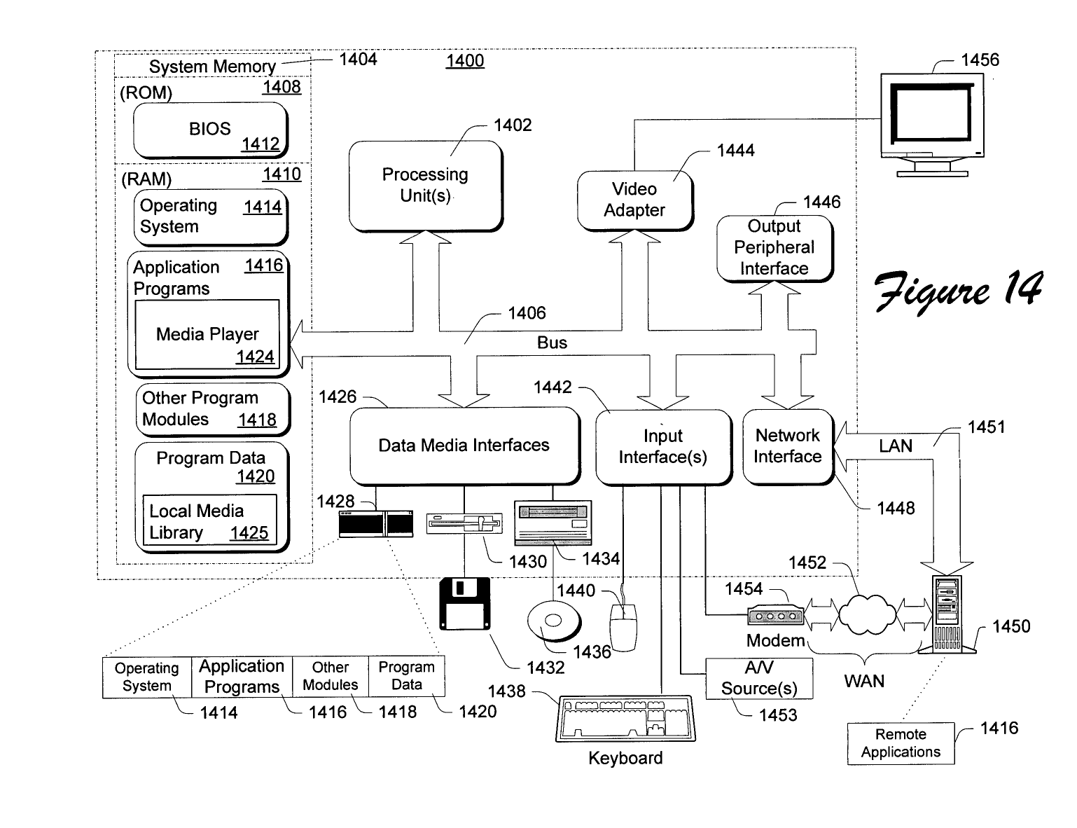

Block 1018 represents the entry point to a method 1300 (described below with reference to FIG. 13) for associating user-submitted metadata with the TOC-less media content in an event that the search does not return a metadata set that is associated with the media content.

FIG. 11 illustrates a method 1100 for associating metadata with TOC-less media content.

At block 1102, the system receives an indication of a user selection of a particular set of metadata that was displayed as a search result (as described above with reference to FIG. 10).

At block 1104, the system stores the user-selected metadata in a local media library stored on the user's computer system. In addition, a media ID that is associated with the metadata is associated with the TOC-less media content. For example, in an exemplary implementation, a binary GUID that represents the media ID is added to the file containing the TOC-less media content. Furthermore, in an exemplary implementation, the attribute tags (e.g. ID3 tags in an MP3 file) are updated to contain a track name, artist name, and album name as represented in the selected metadata.

FIG. 12 illustrates a method 1200 for performing an additional metadata search with modified search criteria.

At block 1202, the system receives an indication of a user selection of an edit search criteria option. For example, as illustrated in FIG. 4, a user may select the refine your search link 402.

At block 1204, the system provides a Wizard user interface screen that enables the user to modify the search criteria. For example, the screen display illustrated in FIG. 7 may be displayed.

At block 1206, the system receives user-submitted modifications to the search criteria. For example, as illustrated in FIG. 7, a user may modify the search criteria and then select the search button 710.

At block 1208, the system submits the modified search criteria to a metadata search system. As described above, with reference to block 1008, in an exemplary implementation, the metadata search system is executed on a server computer system.

Processing then continues as described above with reference to blocks 1010-1018 of FIG. 10.

FIG. 13 illustrates a method 1300 for associating user-submitted metadata with the TOC-less media content in an event that the search does not return a metadata set that is associated with the media content.

At block 1302, the system receives an indication of a user selection of a manual edit option. For example, as illustrated in FIG. 4, a user may select the edit track information link 404.

At block 1304, the system provides a Wizard user interface screen that enables the user to enter metadata to be associated with the TOC-less media content. For example, the screen display illustrated in FIG. 8 may be displayed.

At block 1306, the system receives user-submitted metadata to be associated with the TOC-less media content. For example, as illustrated in FIG. 8, a user may enter metadata in one or more of the displayed fields and then select the save and finish button 814.

At block 1308, the system stores the user-entered metadata in a local media library stored on the user's computer system. In addition, a unique media ID is associated with the metadata and the TOC-less media content. For example, in an exemplary implementation, a binary GUID that represents the media ID is added to the file containing the TOC-less media content. Furthermore, in an exemplary implementation, the attribute tags (e.g. ID3 tags in an MP3 file) are updated to contain some combination of a track name, artist name, and album name if included in the user-submitted metadata.

Exemplary Computer System

FIG. 14 illustrates an exemplary computing environment 1400 in which the inventive systems and methods described above can be implemented.

It is to be appreciated that computing environment 1400 is only one example of a suitable computing environment and is not intended to suggest any limitation as to the scope of use or functionality of the inventive embodiments described above. Neither should the computing environment 1400 be interpreted as having any dependency or requirement relating to any one or combination of components illustrated in the exemplary computing environment 1400.

The inventive techniques can be operational with numerous other general purpose or special purpose computing system environments or configurations. Examples of well known computing systems, environments, and/or configurations that may be suitable for use with the inventive techniques include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

In certain implementations, the inventive techniques can be described in the general context of computer-executable instructions, such as program modules, being executed by a computer. Generally, program modules include routines, programs, objects, components, data structures, etc. that perform particular tasks or implement particular abstract data types. The inventive techniques may also be practiced in distributed computing environments where tasks are performed by remote processing devices that are linked through a communications network. In a distributed computing environment, program modules may be located in both local and remote computer storage media including memory storage devices.

In the illustrated example, computing system 1400 includes one or more processors or processing units 1402, a system memory 1404, and a bus 1406 that couples various system components including the system memory 1404 to the processor 1402.

Bus 1406 is intended to represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

Computer 1400 typically includes a variety of computer readable media. Such media may be any available media that is locally and/or remotely accessible by computer 1400, and it includes both volatile and non-volatile media, removable and non-removable media.

In FIG. 14, the system memory 1404 includes computer readable media in the form of volatile, such as random access memory (RAM) 1410, and/or non-volatile memory, such as read only memory (ROM) 1408. A basic input/output system (BIOS) 1412, containing the basic routines that help to transfer information between elements within computer 1400, such as during start-up, is stored in ROM 1408. RAM 1410 typically contains data and/or program modules that are immediately accessible to and/or presently being operated on by processing unit(s) 1402.

Computer 1400 may further include other removable/non-removable, volatile/non-volatile computer storage media. By way of example only, FIG. 14 illustrates a hard disk drive 1428 for reading from and writing to a non-removable, non-volatile magnetic media (not shown and typically called a “hard drive”), a magnetic disk drive 1430 for reading from and writing to a removable, non-volatile magnetic disk 1432 (e.g., a “floppy disk”), and an optical disk drive 1434 for reading from or writing to a removable, non-volatile optical disk 1436 such as a CD-ROM, DVD-ROM or other optical media. The hard disk drive 1428, magnetic disk drive 1430, and optical disk drive 1434 are each connected to bus 1406 by one or more interfaces 1426.

The drives and their associated computer-readable media provide nonvolatile storage of computer readable instructions, data structures, program modules, and other data for computer 1400. Although the exemplary environment described herein employs a hard disk 1428, a removable magnetic disk 1432 and a removable optical disk 1436, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk 1428, magnetic disk 1432, optical disk 1436, ROM 1408, or RAM 1410, including, by way of example, and not limitation, an operating system 1414, one or more application programs 1416 (e.g., media player 1424), other program modules 1418, and program data 1420 (e.g., local media library 1425). Some of the application programs can be configured to present a user interface (UI) that is configured to allow a user to interact with the application program in some manner using some type of input device. This UI is typically a visual display that is capable of receiving user input and processing that user input in some way. Such a UI may, for example, include one or more buttons or controls that can be selected by a user, using an input device such as a mouse. Media player application 1424 can be any suitable media player application that is configured to play any suitable media so that a user can experience the content that is embodied on the media. Two exemplary media player applications can include a CD media player application and a DVD media player application. Local media library 1425 can be any suitable data storage structure for storing metadata associated with media content that a user accesses through media player application 1424.

Continuing with FIG. 14, a user may enter commands and information into computer 1400 through input devices such as keyboard 1438 and pointing device 1440 (such as a “mouse”). Other input devices may include audio/video input device(s) 1453, a microphone, joystick, game pad, satellite dish, serial port, scanner, or the like (not shown). These and other input devices are connected to the processing unit(s) 1402 through input interface(s) 1442 that is coupled to bus 1406, but may be connected by other interface and bus structures, such as a parallel port, game port, or a universal serial bus (USB).

A monitor 1456 or other type of display device is also connected to bus 1406 via an interface, such as a video adapter 1444. In addition to the monitor, personal computers typically include other peripheral output devices (not shown), such as speakers and printers, which may be connected through output peripheral interface 1446.

Computer 1400 may operate in a networked environment using logical connections to one or more remote computers, such as a remote computer 1450. Remote computer 1450 may include many or all of the elements and features described herein relative to computer 1400.

As shown in FIG. 14, computing system 1400 can be communicatively coupled to remote devices (e.g., remote computer 1450) through a local area network (LAN) 1451 and/or a general wide area network (WAN) 1452. Such networking environments are commonplace in offices, enterprise-wide computer networks, intranets, and the Internet.

When used in a LAN networking environment, the computer 1400 is connected to LAN 1451 through a suitable network interface or adapter 1448. When used in a WAN networking environment, the computer 1400 typically includes a modem 1454 or other means for establishing communications over the WAN 1452. The modem 1454, which may be internal or external, and may be connected to the system bus 1406 via the input interface 1442, or other appropriate mechanism.

In a networked environment, program modules depicted relative to the personal computer 1400, or portions thereof, may be stored in a remote memory storage device. By way of example, and not limitation, FIG. 14 illustrates remote application programs 1416 as residing on a memory device of remote computer 1450. It will be appreciated that the network connections shown and described are exemplary and other means of establishing a communications link between the computers may be used.

### CONCLUSION

The systems and methods described above can greatly enhance the user's media experience when they play TOC-less media content in an enabled player. A robust collection of metadata is available for provision to the user through the use of a data extraction and search process that enables a user to locate metadata associated with the TOC-less media content.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
opening media content that does not include a table of contents;
receiving a request for metadata associated with the media content;
extracting search criteria from the media content;
searching a database that contains media content metadata based on the search criteria;
displaying one or more sets of metadata that, based on the search criteria, may be associated with the media content;
receiving an indication of a user selection of a particular one of the sets of metadata; and
storing the particular set of metadata in a media library, such that the set of metadata is associated with the media content.

2. The method as recited in claim 1 wherein a the media content includes a data structure for storing textual metadata associated with the media content.

3. The method as recited in claim 2 wherein the data structure for storing textual metadata comprises attribute tags for storing at least one of an artist name, an album name, and a track name.

4. The method as recited claim 3 wherein the media content is formatted as an MP3 file and the attribute tags comprise a plurality of ID3 tags.

5. The method as recited claim 1 wherein the extracting comprises identifying an artist name stored in an attribute tag associated with the media content.

6. The method as recited claim 1 wherein the extracting comprises identifying an album name stored in an attribute tag associated with the media content.

7. The method as recited claim 1 wherein the extracting comprises identifying a track name stored in an attribute tag associated with the media content.

8. The method as recited claim 1 wherein the extracting comprises parsing a filename associated with the media content based on a particular character to identify an artist name and a track name.

9. The method as recited claim 1 wherein the extracting comprises identifying a portion of a filename associated with the media content as a track name.

10. The method as recited claim 1 wherein the extracting comprises identifying a portion of a filename associated with the media content as an artist name.

11. The method as recited claim 1 wherein the searching comprises:
expanding the search criteria to include similar search terms; and
searching a music metadata database based on the expanded search criteria to identify metadata that may be associated with the media content.

12. The method as recited claim 1 wherein the searching comprises:
submitting search criteria to a server computer system; and
receiving search results from the server computer system.

13. The method as recited claim 1 wherein the displaying one or more sets of metadata that, based on the search criteria, may be associated with the media content comprises displaying one or more graphical tiles of data, such that each tile displays a track name, an album name, and an artist name.

14. The method as recited claim 13 wherein a tile further displays a track number.

15. The method as recited claim 13 wherein a tile further displays an associated album art.

16. The method as recited claim 13 wherein a tile further displays an associated genre.

17. The method as recited claim 13 wherein a tile further displays an associated record label.

18. The method as recited claim 13 wherein a tile further displays an associated release date.

19. The method as recited claim 1 wherein the storing the particular set of metadata in a media library comprises:
writing the metadata to a media library, such that the metadata is associated with a particular media ID; and
associating the particular media ID with the media content.

20. The method as recited in claim 19, wherein the associating comprises modifying the media content to include the media ID.

21. The method as recited in claim 19, wherein the associating comprises adding a binary GUID that represents the media ID to a file containing the media content.

22. The method as recited in claim 1, wherein the media content comprises an MP3 file.

23. The method as recited in claim 1, wherein the media content comprises an WMA file.

24. The method as recited in claim 1, further comprising:
receiving a request for more details associated with a particular one of the sets of metadata; and
displaying additional data associated with the particular set of metadata.

25. The method as recited in claim 24, wherein the particular set of metadata is associated with a music album, and wherein the additional data comprises a list of tracks associated with the music album.

26. The method as recited in claim 24, wherein the displaying comprises:
submitting a media ID associated with the particular metadata to a server computer system;
receiving the additional data from the server computer system; and
displaying the additional data.

27. One or more computer-readable media having computer-readable instructions thereon which, when executed by a computer, cause the computer to implement the method as recited in claim 1.

28. A method comprising:
opening media content that does not include a table of contents;
receiving a request for metadata associated with the media content;
extracting search criteria from the media content;
searching a database that contains media content metadata based on the search criteria;
displaying one or more sets of metadata that, based on the search criteria, may be associated with the media content;
receiving an indication of a user request to modify the search criteria;
displaying the search criteria to the user;
receiving user-submitted modifications to the search criteria;
searching the database that contains media content metadata based on modified search criteria; and
displaying one or more sets of metadata that, based on the modified search criteria, may be associated with the media content.

29. The method as recited in claim 28 wherein the media content includes a data structure for storing textual metadata associated with the media content.

30. The method as recited in claim 29 wherein the data structure for storing textual metadata comprises structures for storing at least one of an artist name, an album name, and a track name.

31. The method as recited in claim 28, wherein the media content comprises an MP3 file.

32. The method as recited in claim 28, wherein the media content comprises a WMA file.

33. One or more computer-readable media having computer-readable instructions thereon which, when executed by a computer, cause the computer to implement the method as recited in claim 28.

34. A method comprising:
opening media content that does not include a table of contents;
receiving a request for metadata associated with the media content;
extracting search criteria from the media content;
searching a database that contains media content metadata based on the search criteria;
displaying one or more sets of metadata that, based on the search criteria, may be associated with the media content;
receiving an indication of a user request to manually enter metadata to be associated with the media content;
enabling the user to submit metadata;
receiving user-submitted metadata; and
storing the user-submitted metadata in a media library, such that the user-submitted metadata is associated with the media content.

35. The method as recited in claim 34 wherein the storing the user-submitted metadata in a media library comprises:
writing the metadata to a media library, such that the metadata is associated with a particular media ID; and
associating the particular media ID with the media content.

36. The method as recited in claim 35, wherein the associating comprises modifying the media content to include the media ID.

37. The method as recited in claim 35, wherein the associating comprises adding a binary GUID that represents the media ID to a file containing the media content.

38. The method as recited in claim 34, wherein the media content comprises an MP3 file.

39. The method as recited in claim 34, wherein the media content comprises a WMA file.

40. One or more computer-readable media having computer-readable instructions thereon which, when executed by a computer, cause the computer to implement the method as recited in claim 34.

41. A method comprising:
extracting search criteria from media content that lacks a table of contents, the search criteria comprising at least one of a track name, an artist name, and an album name; and
attempting to identify metadata associated with the media content based on the search criteria.

42. The method as recited in claim 41, wherein the extracting comprises identifying data stored in attribute tags associated with the media content.

43. The method as recited in claim 41, wherein the extracting comprises parsing a filename associated with the media content.

44. The method as recited in claim 41, further comprising:
displaying metadata that, based on the search criteria, may be associated with the media content;
receiving user selection of a particular set of the displayed metadata; and
maintaining the particular set of metadata in a media library, such that the metadata is associated with the media content.

45. The method as recited in claim 41, further comprising:
if metadata associated with the media content is not found:
enabling a user to modify the search criteria; and
attempting to identify metadata associated with the media content based on modified search criteria.

46. The method as recited in claim 45 wherein said enabling comprises causing a Wizard user interface (UI) to be presented to a user via a client computer so that information pertaining to the media content can be collected from the user.

47. The method as recited in claim 41, further comprising:
if metadata associated with the media content is not found:
enabling a user to enter metadata to be associated with the media content; and
maintaining user-submitted metadata in a media library, such that the user-submitted metadata is associated with the media content.

48. The method as recited in claim 47 wherein said enabling comprises causing a Wizard user interface (UI) to be presented to a user via a client computer so that information pertaining to the media content can be collected from the user.

49. The method as recited in claim 41, wherein media content comprises an MP3 file.

50. One or more computer-readable media having computer-readable instructions thereon which, when executed by a computer, cause the computer to implement the method as recited in claim 41.

51. A method comprising:
identifying search criteria associated with media content, the media content lacking a table of contents;
searching a database for metadata to be associated with the media content, the search based on the search criteria; and
if no metadata to be associated with the media content is found, attempting to identify more accurate search criteria by causing a Wizard user interface (UI) to be presented to a user via a client computer so that information pertaining to the media content can be collected from the user.

52. The method as recited in claim 51 further comprising receiving information from the user, via the Wizard UI, the information pertaining to the media content.

53. The method as recited in claim 51, wherein the media content comprises an MP3 file, and the information collected by the Wizard UI comprises an artist's name.

54. The method as recited in claim 51, wherein the specific media comprises an MP3 file, and the information collected by the Wizard UI comprises an album name.

55. The method as recited in claim 51, wherein the specific media comprises an MP3 file, and the information collected by the Wizard UI comprises a track name.

56. The method as recited in claim 51 further comprising searching the database for metadata based on the information collected by the Wizard UI.

57. A method comprising:
identifying search criteria associated with media content, the media content lacking a table of contents;
searching a database for metadata to be associated with the media content, the search based on the search criteria; and
if no metadata to be associated with the media content is found, attempting to identify metadata to be associated with the media content by causing a Wizard user interface (UI) to be presented to a user via a client computer so that information pertaining to the media content can be collected from the user.

58. The method as recited in claim 57 further comprising receiving information from the user, via the Wizard UI, the information pertaining to the media content.

59. The method as recited in claim 57, wherein the media content comprises an MP3 file.

60. The method as recited in claim 57, wherein the information collected by the Wizard UI comprises at least one of an artist's name, an album name, a track name, a track number, and a genre.

61. The method as recited in claim 57 further comprising storing the information collected by the Wizard UI in a media library such that the information is associated with the media content.

62. A system comprising:
a processor;
a memory;
a media player application stored in the memory and executed on the processor for playing media content that lacks a table of contents;
a media library stored in the memory for maintaining metadata associated with the media content; and
a Wizard UI configured to enable a user to modify search criteria associated with the metadata to be used to identify metadata associated with the media content, the metadata to be stored in the media library.

63. The system as recited in claim 62 wherein the Wizard UI is further configured to enable a user to submit user-entered metadata to be associated with the media content in the media library.

64. A system comprising:
means for extracting search criteria from media content that lacks a table of contents;
means for locating metadata that may be associated with the media content based on the search criteria; and
means for displaying the metadata that may be associated with the media content to a user.

65. The system as recited in claim 64 further comprising means for enabling user modification of the search criteria.

66. The system as recited in claim 64 further comprising:
means for enabling a user to submit metadata to be associated with the media content; and
means for associating the metadata with the media content.

67. The system as recited in claim 64 further comprising:
means for enabling user selection of metadata to be associated with the media content; and
means for associating the metadata with the media content.

68. One or more computer-readable media comprising computer-readable instructions which, when executed, cause a computer system to:
extract search criteria from media content that does not include a table of contents; and
perform a search based on the search criteria, the search returning one or more sets of metadata that may be associated with the media content.

69. The one or more computer-readable media as recited in claim 68, further comprising computer-readable instructions which, when executed, cause a computer system to display a Wizard UI that enables a user to modify the search criteria.

70. The one or more computer-readable media as recited in claim 68, further comprising computer-readable instructions which, when executed, cause a computer system to:
provide a Wizard UI that displays the one or more set of metadata;
enable a user to select a particular set of metadata; and
associate the particular set of metadata with the media content.

71. The one or more computer-readable media as recited in claim 68, further comprising computer-readable instructions which, when executed, cause a computer system to:
enable a user to submit metadata to be associated with the media content; and
associate the user-submitted metadata with the media content.
